(19) United States
(12) Patent Application Publication
(10) Pub. No.: US 2016/0217497 A9
(43) Pub. Date: Jul. 28, 2016

(54) SYSTEM AND METHOD FOR BRAND ADVERTISING ON A GLOBAL COMPUTER NETWORK

(71) Applicant: Tara Chand Singhal, Torrance, CA (US)

(72) Inventor: Tara Chand Singhal, Torrance, CA (US)

(21) Appl. No.: 13/769,515

(22) Filed: Feb. 18, 2013

Related U.S. Application Data
(60) Provisional application No. 61/758,702, filed on Jan. 30, 2013.

(51) Int. Cl. G06Q 30/02

(52) U.S. Cl. CPC G06Q 30/0272

(57) ABSTRACT

A system for brand advertising on a global network of computers has a digital content that is created and stored on a server. The digital content embeds an advertising image and the digital content is structured in a manner that the advertisement image is the first display seen by a receiver client when the digital content is received from a server on the global network and viewed on the client. The advertising image substantially obscures the digital content from being viewed and removes the image from the display after a time threshold, thus enables the digital content to be viewed. The image is displayed for a time threshold that is programmed to a time period that is equal to or less than 3.5 seconds and the viewing of the image cannot be bypassed until the expiry of the time threshold.

### CROSS REFERENCE

This application claims priority from U.S. provisional application No. 61/758,702, titled “Apparatus And Method For Brand Advertising On A Global Computer Network”, filed Jan. 30, 2013, of Tara Chand Singhal. The application Ser. No. 61/758,702 is incorporated herein by reference.

### FIELD OF THE INVENTION

Embodiments of a system and a method for brand advertising on digital media, where the ad image substantially obscures delivered digital content for a limited period of time before being automatically removed, are described.

### BACKGROUND

There are many different approaches to advertising. Some of them include, brand advertising, display of products and services providing an impetus to make a purchase on the spot, and advertising that describe the types and nature of product made by a business. Others types of advertising include advertising that stress quality of a business's products, their attributes of competitive prices and customer satisfaction.

There are different types of media for advertising such as print media, radio and television. Increasingly now-a-days digital media is being used. Such digital media includes web-delivered content.

The audience for the advertising is determined by the type of base content that is attractive to an audience in which the advertising is delivered. The advertising may be direct or indirect. The direct advertising covers the features of the product and service and is displayed directly to an audience. The indirect advertising takes the help of other digital content such as movies and sports events.

There are also different players in the advertising industry such as the product/service companies, the ad creators, the media buyers and the media itself. The companies are looking for the best advertising media for their products and services and many times that is a hit and miss approach.

Wireless mobile communication devices, also known as smart phones, have become very common and have been acquired and are carried in their personal possession by the masses due to their low cost, convenience, and functionality. Now that has been also supplemented by tablet computers.

The digital media is considered ideal media for advertising because of many features that it provides that are not provided by the traditional media such as TV radio and print. However, advertising via digital media has a high potential to irritate and alienate the customer.

The use of digital media is evolving. At one time banner ads on web pages were very popular. However, their effectiveness has been very low as people ignore them. Then the advertisers tried placement of advertisement on margins of a webpage because as a viewer scrolled the webpage the viewer was forced to see these ad images on the margins. This form of advertising also has proven to be not very effective.

To overcome the limitations of the advertisement on web pages as described above, recently the advertisers have come up with a different approach. In this approach, the advertisers place an advertising image in the middle of the digital content on a web page. Recently this form of ad placement on web pages has become a very common approach in the news stories and web pages of magazines and newspapers.

In this form of advertising, the ad image that is placed in the middle of webpage to obscure the underlying digital content and the ad image has to be closed by the viewer by finding a click to close button. Many times the click to close button is tiny and not easy to find in a hurry.

In the alternative, without having to click the ad image to close, the ad image disappears after so many seconds on its own. That period is usually close to five seconds. These ads are irritating to the viewer for having distracted them from viewing the content. Over time they may also prove to be less effective like the banner and margin ads on a webpage.

The problem is further compounded by the smart phone devices which have limited display screen sizes and where the web pages were developed for standard screen sizes that are commonly used in laptop and desktop computers

Hence it is the objective of the embodiments herein to have different forms of advertising suitable for digital media that does not irritate the customer and yet is effective in carrying the company message to their customers.

### SUMMARY

There are many types of advertisement. One of these types of advertisement is called brand advertising. One typical such brand awareness ad is displaying an advertiser's logo at a sports event. A video camera panning the playing field or court during the sports action shows to a large audience on their televisions the logo image of the advertiser for a brief period. Such typical sports may include tennis and basketball.

A brand awareness ad image for an advertiser fulfills a critical need for an advertiser in keeping the awareness of the company via their brand name and/or logo before their customers. Who does not know the Coca Cola brand, yet Coca Cola Company has a large budget for brand advertising to keep the awareness of the Coca Cola brand in front of their customer. The brand advertisement acts as a reminder to the viewer and refreshes the viewer's mind about the existence of the company and/or its products. The brand ads are simple, of short duration, and largely focused on displaying a company's name and or a slogan and/or a product image.

With the advent of mobile wireless devices that are increasingly being used to receive live and stored content, these do not provide such facility to an advertiser for brand advertising, as in any advertisement, the potential is very high to irritate the customer by displaying ads on such a personal mobile device.

A system of brand advertising of the embodiments herein on a global network of computers may solve this dilemma and may be suited specifically for brand awareness advertising.

The system has a digital content that is created and stored on a server. In some embodiments, the digital content embeds an advertising image and the digital content is structured in a manner that the advertisement image is the first display seen by a receiver client when the digital content is received from a server on the global network and viewed on the client.

In an alternative embodiment, the digital content embeds an advertising image and the digital content is structured in a manner that the advertisement image is first displayed on a receiver client after some time delay after the digital content has been received from a server on the global network and then is being viewed on the client.

The digital content may include any type of content that is digitally stored, digitally sent, digitally received and displayed on a display screen of the device. The digital content may have a format of a web page, a document, a book, an image and a video.

The advertising image substantially obscures the digital content from being viewed and removes the image from the display after a time threshold, thus enabling the digital content to be viewed. Thus the viewer would know that the requested digital content has been received and is being displayed on their device.

The digital content is substantially obscured when the viewer can discern that there is an underlying document, web page, a book or an image underneath the ad image, but they are unable to make use of it by viewing it for reading or being displayed images.

In some embodiments, the image is displayed for a time threshold that is programmed to a time period that is equal to or less than 3.5 seconds and the viewing of the image cannot be bypassed until the expiry of the time threshold. Such a period of 3.5 seconds or less is believed to be short enough that minimizes the irritation of the viewer.

In some embodiments, the image is displayed for a time threshold that is programmed to be a time period that is equal to or less than 2.9 seconds and the viewing of the image cannot be bypassed until the expiry of the time threshold. Such a period of 2.9 seconds or less is believed to be short enough that minimizes the irritation of the viewer and at the same time makes an impression on the viewer's mind.

It is believed that the viewer irritability starts somewhere between 3 and 4 seconds, where a 3 second duration ad is not irritable, and a 4 second or more duration ad is considered irritating. Therefore, time duration of 3.5 seconds or less is a safe maximum level to avoid irritation of the viewer. It is believed that in such a short time for a viewer, the viewer mentally does not have time to build resentment against the advertisement and the advertised brand or product.

As a matter of reference, an image in a slide show is shown for a period around five seconds. While such a long time is considered adequate for a slide show, when used for an advertisement on a digital media when the ad obscures the digital content it is believed to be irritating to the viewer and is resented. That may have the potential of harming the brand name in the viewer's mind.

When an ad is unwanted and irritable, the viewer mentally tunes out the value and the impact of the advertisement. As an illustration, reference “Measuring the Intrusiveness of Advertisement: Scale Development and Validation”, by Hairong Li, Steven M. Edwards, and Joo-Hyun Lee, Journal of Advertising, Volume XXXI, Number 2, Summer 2002, illustrates in some detail the intrusiveness and the irritability of ads to a viewer.

For example, on a television ad, where the ad is likely to last 15 or 30 seconds, the viewer most likely tunes out the impact and the value of the advertisement.

The advertising industry had developed techniques to work around this limitation of ads that are long. One approach has been to use the bulk of the ad time for an unrelated story or drama that is enticing to a viewer and provide the ad content for a short duration in the end of the ad time period. This approach is used in the radio, television, and print advertisement.

The viewer does not know how long the image would be displayed for and thus may perceive all ad images irrespective of duration to be irritating. To alleviate this concern, in some embodiments a social message may be included along the ad image that can be mentally comprehended in a time duration of less than 3.5 seconds that is designed to generate goodwill for the brand and the product and thus remove any aspect of irritation.

Further still, the ad image may have a legend notifying the viewer of the brief nature of time the ad image is being displayed. The legend may be displayed as a water mark feature on a part of the image that is easily perceived by a viewer and lets a viewer know that these ads are not meant to irritate the viewer but to serve a useful purpose by generating revenue for having provided free digital content.

As a simplified illustration, a logo or words or images of “minimalist” on an ad image may convey to a viewer the nature of this specific kind of time limited advertisement and thus rules out at the outset any build up of irritation and thus resentment against the advertiser and its brand and products

These and other aspects of the embodiments herein are further described in detail with the help of the accompanying drawings and the description.

### BRIEF DESCRIPTION OF THE DRAWINGS

Some of the novel features of the embodiments will be best understood from the accompanying drawings, taken in conjunction with the accompanying description, in which similar reference characters refer to similar parts, and in which:

FIGS. 1A and 1B are block diagrams that illustrate features of a system brand advertisement on a global computer network.

FIG. 2 is a diagram that illustrates features of a brand advertisement using mobile wireless communication device.

FIGS. 3A and 3B are diagrams that illustrates features of a brand advertisement system using a global computer network.

FIGS. 4A, 4B, 4C and 4D illustrate simplified examples of brand advertisement using mobile wireless communication device.

FIG. 5 is a method diagram that illustrates features of a brand advertisement using global computer network.

### DESCRIPTION

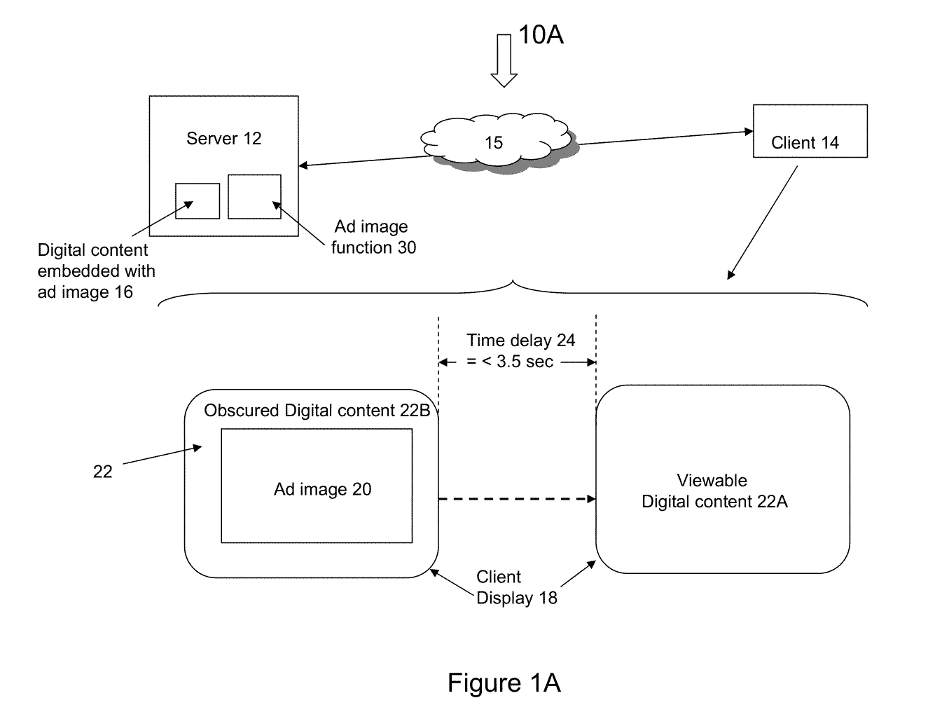

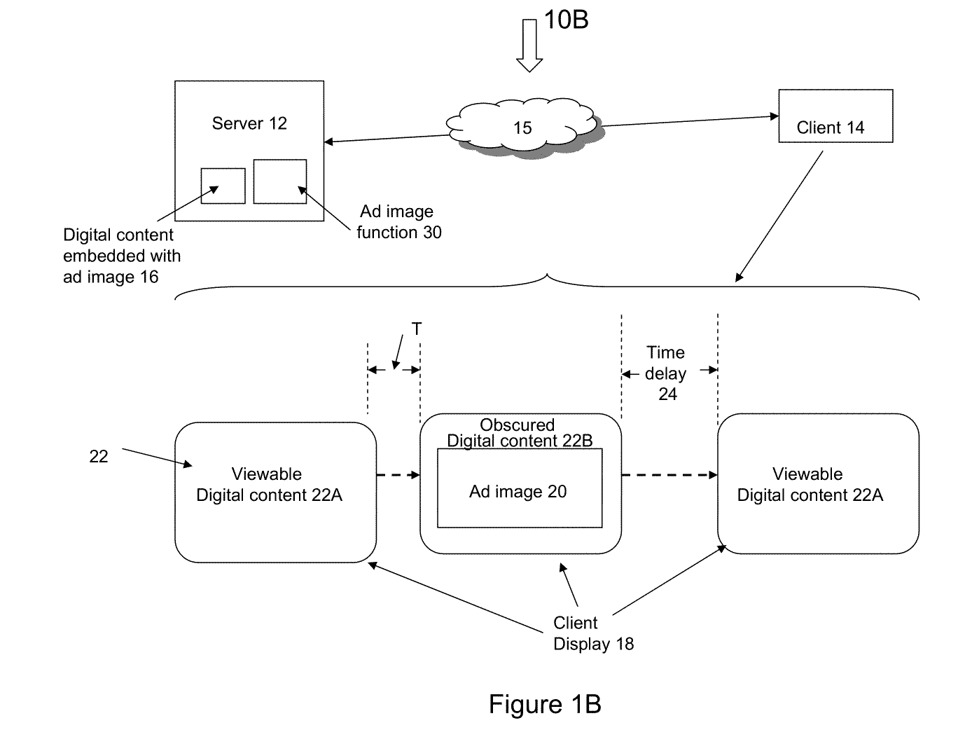

FIGS. 1A and 1B illustrate embodiments 10A and 10B respectively of a brand advertising system on a global computer network 15.

As illustrated in FIG. 1A, a brand advertisement system 10A of the embodiments herein, on a global computer network 15, has a server 12 that communicates with a client 14. The server 12 stores digital content 16 embedded with a plurality of ad images.

The digital content 16 is delivered to the client 14 by the server 12 on client 14 request. The client display 18 shows digital content 22. The digital content 22 is obscured or obscured digital content 22B that is substantially obscured by an ad image 20.

After a delay of a time threshold 24 the ad image 20 is automatically removed providing for a viewable digital content 22A. The time delay 24 for the time threshold is from a period of 0.7 seconds to less than or equal to 3.5 seconds depending upon the ad image. Alternatively, the time delay for the threshold is from a period of 0.7 seconds to less than or equal to 2.9 seconds depending upon the ad image.

As illustrated in FIG. 1B, a brand advertisement system 10B of the embodiments herein, on a global computer network, has a server 12 that communicates with a client 14. The server 12 stores digital content 16 embedded with a plurality of ad images.

The digital content 16 is delivered to the client 14 by the server 12 on client 14 request. The client display 18 shows digital content 22. The ad image 20 is displayed after a time delay T. After a delay of a time threshold 24 the ad image 20 is automatically removed providing for a viewable digital content 22A.

As illustrated in FIG. 1B, when the digital content is received into the client, the display 18 shows viewable digital content 22A. After a time delay of T, the ad image 20 is displayed obscuring the digital content making for an obscured digital content 22B. After a time delay 24, the ad image 20 is automatically removed or dissolved providing a viewable digital content 22A again.

As a simplified illustration, the time T may be in seconds and may be a time such as 5 seconds or 10 seconds etc. The time T may be determined to be a random number between two limits so that the viewer cannot anticipate when the ad image 20 may appear. These times provide ample time to view parts of the digital content 22A before the ad image 20 appears on top of the digital content. The time T may be different for different types of content such as images, text and video. The time T may be up to 30 seconds for video digital content. If the digital content is a book or a long video, the book or the video is divided into chapters or segments and each chapter or the segment may be considered new digital content for the purposes of placing ads in the embodiments herein.

The time delay 24 for the time threshold is from a period of 0.7 seconds to less than or equal to 3.5 seconds depending upon the ad image. Alternatively, the time delay 24 for the time threshold is from a period of 0.7 seconds to less than or equal to 2.9 seconds depending upon the ad image.

There are two end time thresholds. The first one is estimated based on not making or being perceived as a subliminal advertisement by a viewer. The other is estimated on not being irritating to the customer.

In general advertisements are disliked by average customers, specifically if they hinder them in some manner and delay access to what they want. See reference “Measuring the Intrusiveness of Advertisement: Scale Development and Validation”, by Hairong Li, Steven M. Edwards, and Joo-Hyun Lee, Journal of Advertising, Volume XXXI, Number 2, Summer 2002, illustrates in some detail the intrusiveness and the irritability of ads to a viewer.

There are two visual time thresholds, one for subliminal advertising and the other based on irritability of a customer when forced to look at an advertisement in the middle of a task that he/she is engaged in. The first one may be considered a deceptive form of advertising and the later one is commonly being used on TV and digital media in the form of web pages and is disliked but tolerated as the customer has no choice when viewing digital content of his choice which may be free to him/her.

These time threshold limits may be different but are believed to be 0.7 second for subliminal ads and generally about 3 seconds for not to cause the viewer to be irritated. Hence, the lower time limit may be 0.7 second and the higher limit may be 3.5 seconds or less.

When a brand ad is displayed for a time period of 3.5 second or less, according to the embodiments herein the viewer is not aware for how long the image is being displayed and thus cannot differentiate these ads from prior art ad images as described in the background section, which provide ads for a duration of many seconds, greater than 3.5 seconds, believed to be five seconds and/or requires the user to click a close button on the ad image.

Prior art also displays ad images on received digital content that obscures the bulk of the digital content from being viewed. However, it is believed, prior art requires clicking a close button on the ad image to remove it or the ad image is displayed for a period much longer than 3.5 seconds before being automatically removed.

The web and software technology itself of creating such time limited ads is prior art. Such technologies may use HTML and Flash languages and applications. In the future there may be newer or different such languages and applications.

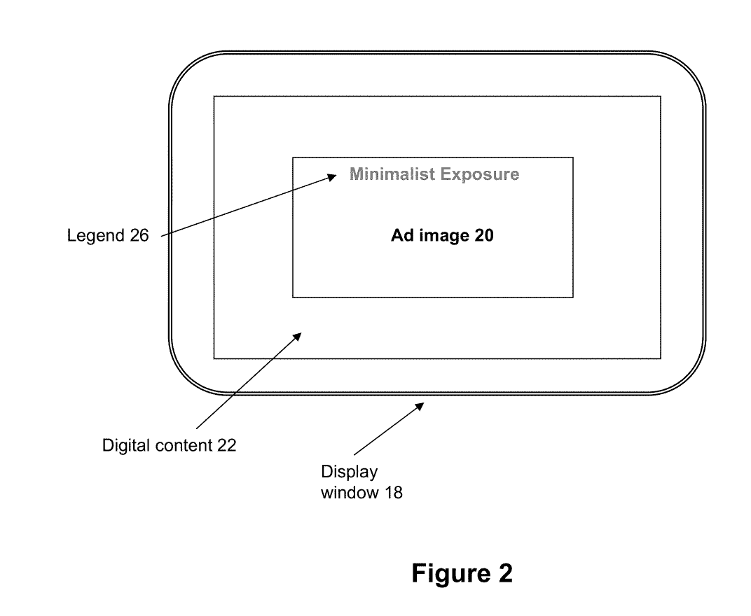

As shown in FIG. 2, the ad image 20 may have a legend 26 notifying the viewer of the brief nature of time the image is being displayed and also to distinguish the ad images of the embodiments herein from prior art for a viewer.

The legend 26 may be displayed as a water mark feature on a part of the ad image 20. The water mark feature may be of a kind that signifies to a user the duration of the ad image display time such as 1 second, or 2 second or less than 3 seconds.

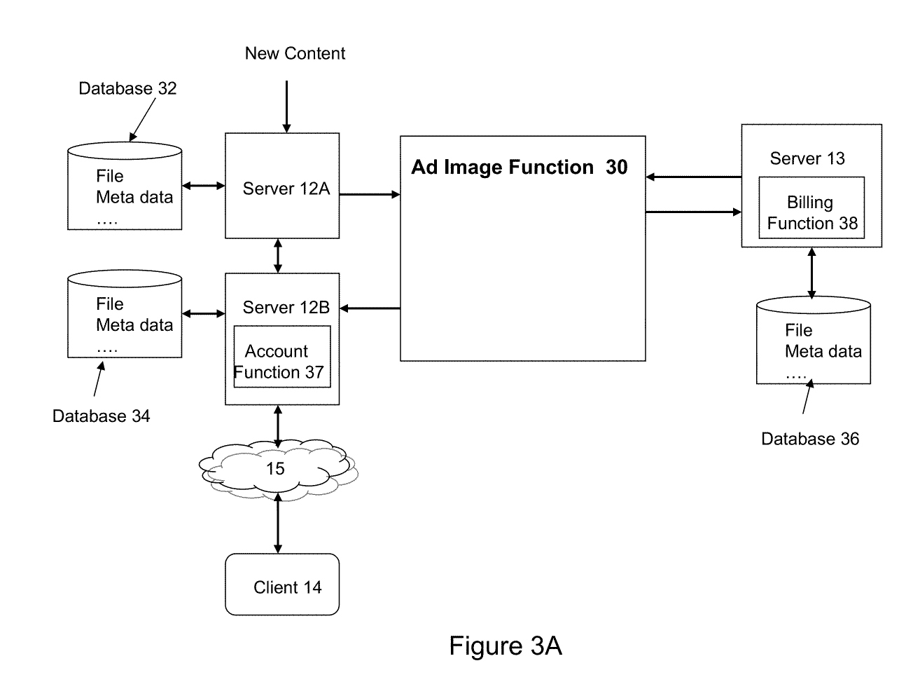

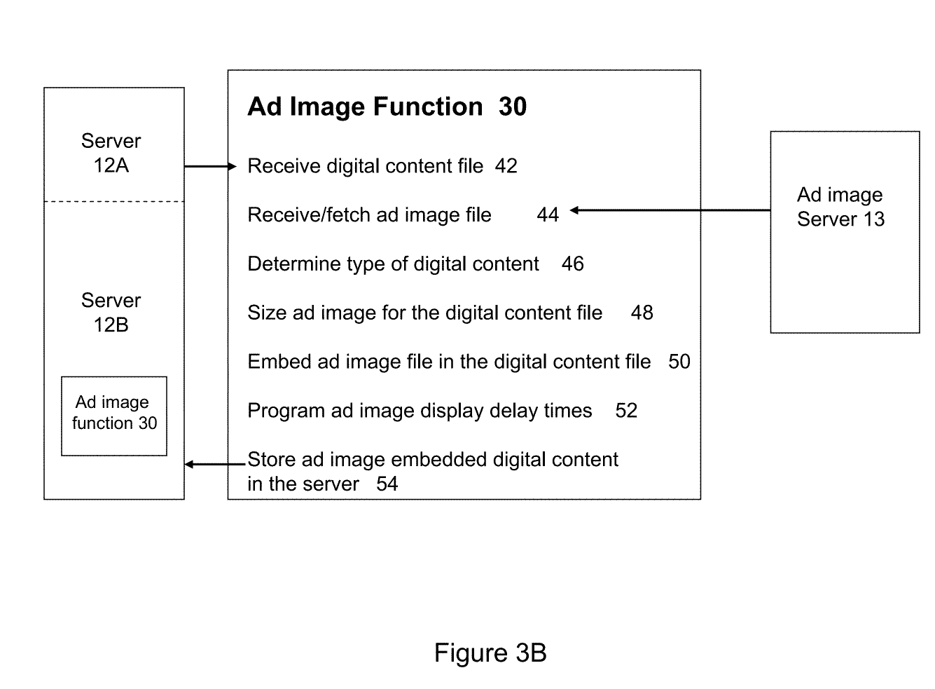

FIG. 3A illustrates the operation of the brand advertising systems 10A and 10B. A server 12A receives and stores new, changing, or fresh digital content. This may come from any variety of sources on a global network. It may be user-generated such as You tube videos or it may be professionally generated such as by the news media.

The server 12A has an associated database 32 that stores the digital content files, where each file has an associated meta data that describes the attributes of the digital content file. The technology of data file and their meta data for storage in a database is prior art technology.

There is an ad image function 30 that is operative in the server 12B. The details of the ad image function 30 are illustrated later here with the help of FIG. 3B. In brief, the ad image function 30, fetches ad images from the ad image server 13 and its associated database 36 and fetches digital content from server 12A and its associated database 32 and, embeds the ad image in the digital content and stores the ad image embedded digital content in the server 12B and its associated database 34.

The server 12B may be separate than server 12A or it may be part of the same server. The server 12B has an associated database 34. The database 34 stores digital content that has been embedded with ad images that had been fetched from an ad image server 13. Again the content files in database 34 have their associated meta data that defines not only the attributes of the digital content but also of the ad image embedded in the digital content.

The server 12B receives request from client 14 on the global network 15 and sends ad image embedded digital content to the clients 14. There is an accounting function 37 in the server 12B that keeps track of and an accounting of what ad images and types of content have been sent to the clients. The server 13 has a billing function 38, that based on the accounting function 37 data, prepares billing statements for the advertisers based on the ad images and their frequency that have been sent to the clients 14. The revenue that is received from the advertisers may be shared with the digital content creators.

FIG. 3B illustrates ad image function 30. The function 30 has sub-function 42 of fetch/receive digital content file from the server 12A and function 44 for fetch/receive ad image file from an ad image server 13.

The ad image server 13 may be a server that is positioned elsewhere on the global net and may be in the control of a business entity different than the entity that controls the server 12. Each ad image in the server 13 is stored with meta data that enables the function 30 to retrieve the ad image that is appropriate for the digital content. The digital content in the server 12B is stored with meta data. Function 46 determines type of digital content from types such as video, web page, document etc.

The function 48 sizes the ad image for the digital content file and function 50 embeds the ad image in the digital content file. Function 52 programs the ad image display delay time 24 and the delay time T. Function 54 stores the ad image embedded digital content in the server 12B in a part of the server for retrieval of the digital content by a client 14.

The ad image function 30 executes periodically and includes new or changing or even the same digital content in the server 12A and reads new ad images from the server 13 to embed in the digital content thus constantly cycling or refreshing the ad images in the digital content. Therefore a viewer may not be exposed to the same ad image. The number of impressions an ad image may be displayed in a given time period is contained in the meta data of the ad image as well as the nature of the ad image and its suitability for different types of digital content.

As a simplified illustration, the meta data of an ad image may include frequency of 1000 in 10 days and include type of ad image as technical enterprise or apparel enterprise so that the function 30 would embed the ad image based on the coding of the type of digital content. A technical news item may embed a computer company ad image and shopping news item may embed an image of an item of apparel.

The format of the stored data items in a database server with database application software with their meta data is prior art and is commonly used in the global network systems.

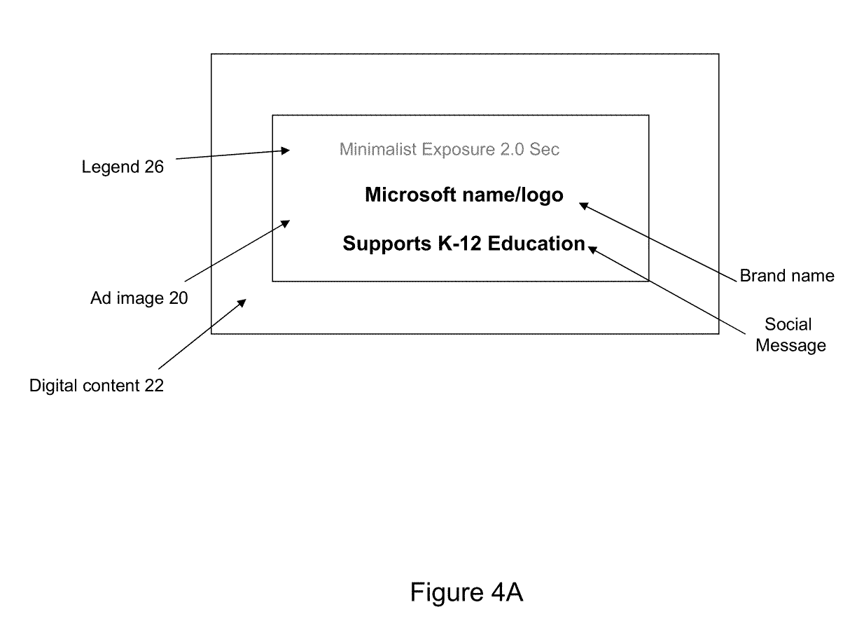

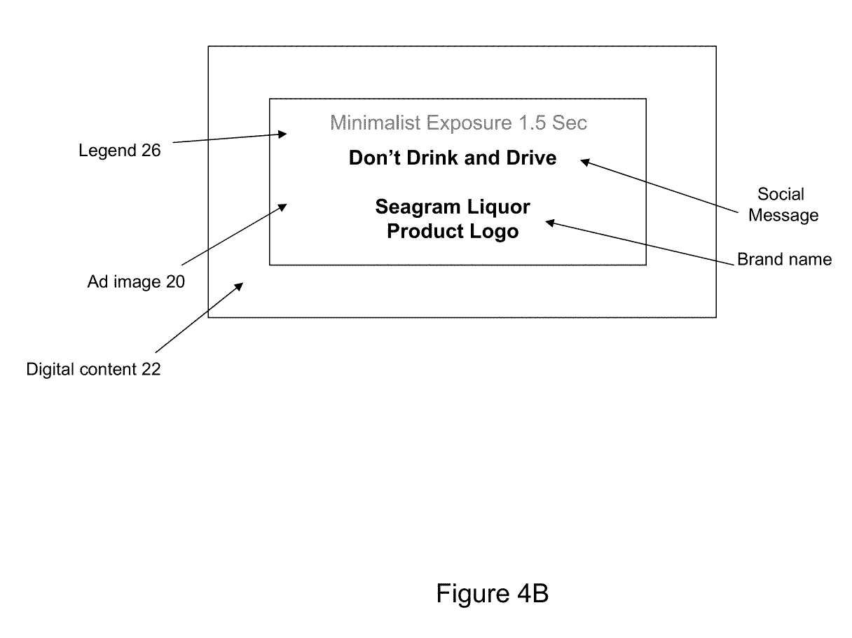

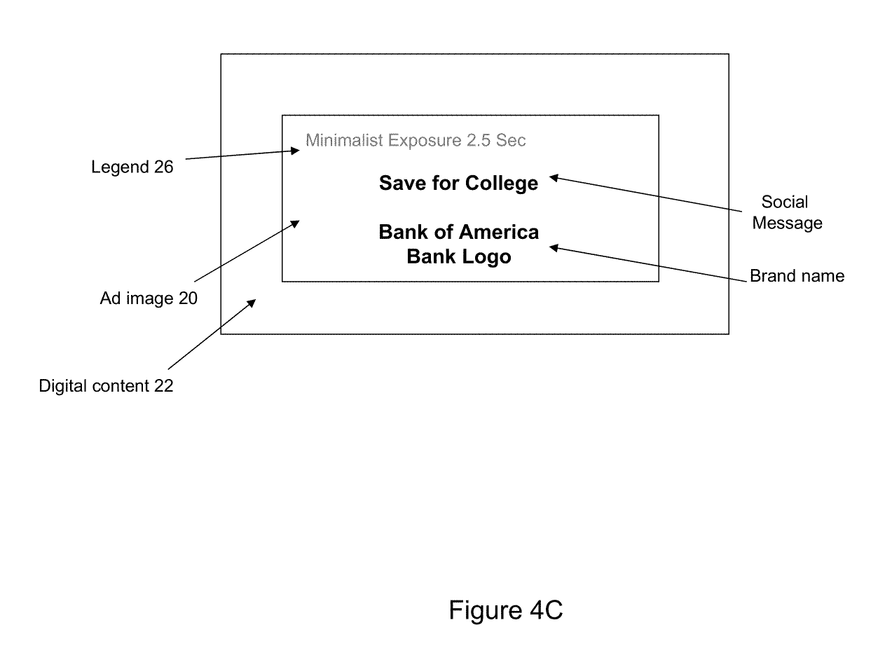

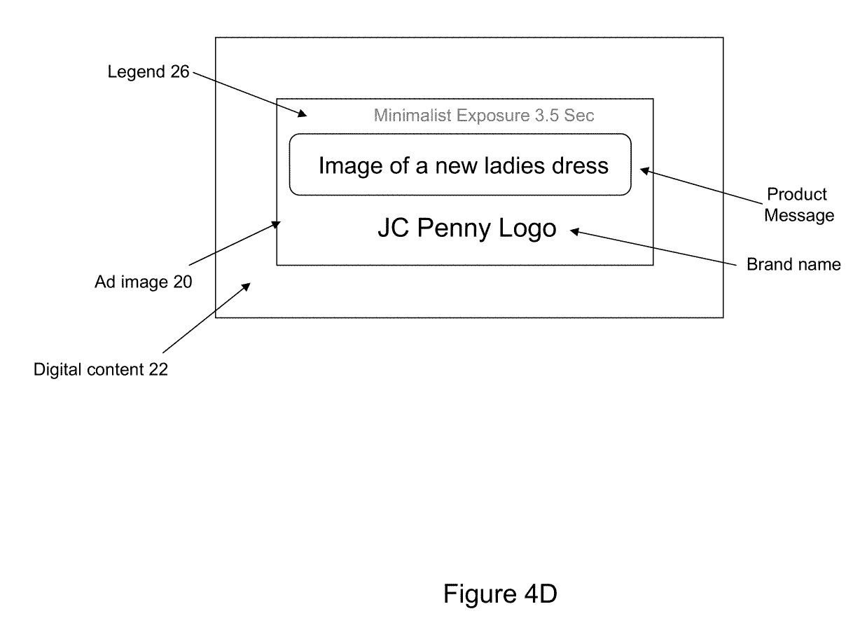

FIGS. 4A, 4B, 4C and 4D provide simplified illustrations of the ad-image of the embodiments herein. FIG. 4A, the ad image shows a legend 26 that the viewer would note that this ad image is for a limited time period and the brand logo and a social message supported by the brand.

FIG. 4B, the ad image shows a legend 26 that the viewer would note that this ad image is for a limited time period the brand logo and a social message supported by the brand.

FIG. 4C, the ad image shows a legend 26 that the viewer would note that this ad image is for a limited time period, the brand logo and a social message supported by the brand.

FIG. 4D, the ad image shows a legend 26 that the viewer would note that this ad image is for a limited time period the brand logo and a product image supported by the brand.

In each of these illustrations, the time period of the ad image duration may be different. As a simplified illustration the ad image in FIG. 4D, which shown a product image that of a female dress, that may require a longer mental time to absorb, the time limit may be 3.5 seconds.

As simplified illustration the ad image in FIG. 4B, which shows a social message, the ad time may be relatively less and may be close to 1.5 seconds to make a mental impression of a well known social message.

As simplified illustration the ad image in FIG. 4C, which shows a commercial/social message, the ad time may be relatively less and may be close to 2.5 seconds to mentally absorb the message and the brand.

As simplified illustration the ad image in FIG. 4A, which shows a commercial/social message, the ad time may be relatively less and may be close to 2.0 seconds to mentally absorb the message and the brand.

In an alternative embodiment 10B, as illustrated with the help of FIG. 1B, the system for brand advertising on a global network of computers has a server on a global computer network with stored digital content that is sent to clients on the global net on a specific request for it.

A function embeds an advertising image in the digital content, where the advertising image, when viewed, substantially obscures the digital content from being viewed. The function structures the digital content in a manner that the advertisement image is seen by a receiver client after a preprogrammed time delay T after the digital content is received from the server via the global network. The function removes the image from the display after a time threshold, thus enabling the digital content to be viewed.

The preprogrammed time delay T is programmed to be substantially between 5 seconds and 30 seconds and is dependent upon the nature of the digital content.

The advertising image is displayed for a time threshold that is programmed to a time period that is equal to or less than 3.5 seconds and the viewing of the image cannot be bypassed until the expiry of the time threshold.

In a yet another alternative embodiment, the time threshold is programmed to be greater than or equal to 0.7 seconds and less than and equal to 2.9 seconds.

A system for brand advertising on a global network of computers has a server on a global computer network with stored digital content that is sent to clients on the global net when a specific request has been made for it by the client. A function embeds an advertising image in the digital content, where the advertising image when the content is displayed on a client, substantially obscures the digital content from being viewed.

The function structures the advertisement image in the digital content in a manner that the ad image is the first display seen by a receiver client when the digital content is received from the server on the global network and viewed on the client and removes the ad image from the display after a time threshold, thus enabling the digital content to be viewed. The advertising image is displayed for a time threshold that is programmed to a time period that is equal to or less than 3.5 seconds and the viewing of the image cannot be bypassed until the expiry of the time threshold.

The ad image is displayed for a time that exceeds at least the time for a subjective subliminal perception. With a safe margin that is believed to be of 0.7 seconds. The time period for displaying the image is limited to one from a group of, 0.7, 0.8, 0.9, 1.0, 1.1, 1.2, 1.3, 1.4, 1.5, 1.6, 1.7, 1.8, 1.9, 2.1, 2.2, 2.3, 2.4, 2.5, 2.6, 2.7, 2.8, or 2.9 seconds time period.

The ad image is one from a group of (i) a composite of a part A that of a social message and part B that of a social message sponsor, (ii) a brand awareness image for brands of one or more businesses, or (iii) a product or service awareness image of a business.

The social message part A of a composite ad image is one from a group of (i) related to health issues, (ii) related to financial literacy, or (iii) related to habits targeted to a specific audience. The social message sponsor part B of a composite ad image is one from a group of (i) a for-profit business, (ii) a non-profit organization, or (iii) a government agency.

The image is created with a plurality of images that are viewable within the time threshold. The multiple images are created when the digital content has multiple sections and a single advertising image is used for each section of the digital content. The function at random decides which image would be displayed for which section of the digital content by embedding it in the digital content.

The ad image has a legend notifying the viewer of the brief nature of time the image is being displayed. The legend may be displayed as a watermark feature on a part of the image.

A system for brand advertising on a global network of computers has a server on a global computer network with stored digital content that is sent to clients on the global net on a specific request for it.

A function embeds an advertising image in the digital content, where the advertising image when viewed substantially obscures the digital content from being viewed. The function structures the digital content in a manner that the advertisement image is seen by a receiver client after a preprogrammed time delay T after the digital content is received from the server via the global network and viewed on the client and removes the image from the display after a time threshold, thus enables the digital content to be viewed. The advertising image is displayed for a time threshold that is programmed to a time period that is equal to or less than 3.5 seconds and the viewing of the image cannot be bypassed until the expiry of the time threshold.

The time threshold is programmed to greater than and equal to 0.7 seconds and less than and equal to 2.9 seconds. The preprogrammed time delay T is programmed to be substantially between 5 seconds and 30 seconds and is dependent upon the nature of the digital content. The nature of digital content may vary and some contents are viewed quickly and some take longer time to read and comprehend. Large amount of text takes longer to comprehend than limited text or some images. Therefore the time T may be adjusted in proportion to the nature of the underlying digital content.

### Method of Operation

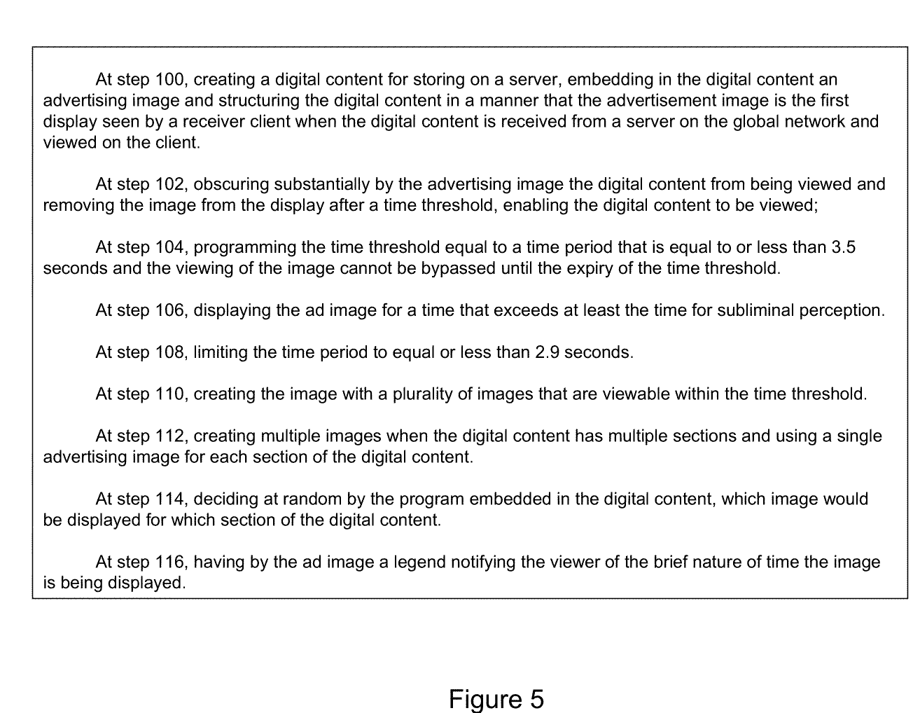

With reference to FIG. 5, steps of a method for brand advertising on a global network is illustrated, where not all the steps may be used or used in the order specified.

At step 100, creating a digital content for storing on a server, embedding in the digital content an advertising image and structuring the digital content in a manner that the advertisement image is the first display seen by a receiver client when the digital content is received from a server on the global network and viewed on the client.

At step 102, obscuring substantially by the advertising image the digital content from being viewed and removing the image from the display after a time threshold, enabling the digital content to be viewed;

At step 104, programming the time threshold equal to a time period that is equal to or less than 3.5 seconds and the viewing of the image cannot be bypassed until the expiry of the time threshold.

At step 106, displaying the ad image for a time that exceeds at least the time for subliminal perception.

At step 108, limiting the time period to less than or equal to 3.5 seconds.

At step 110, creating the image with a plurality of images that are viewable within the time threshold.

At step 112, creating multiple images when the digital content has multiple sections and using a single advertising image for each section of the digital content.

At step 114, deciding at random by the program embedded in the digital content, which image would be displayed for which section of the digital content.

At step 116, having by the ad image a legend notifying the viewer of the brief nature of time the image is being displayed.

In summary, the preferred embodiments are for a system for brand advertising on a global network of computers that has a digital content that is created and stored on a server, where the digital content embeds an advertising image and the digital content is structured in a manner that the advertisement image is the first display seen by a receiver client when the digital content is received from a server on the global network and viewed on the client.

The advertising image substantially obscures the digital content from being viewed and removes the image from the display after a time threshold, thus enables the digital content to be viewed.

The ad image is displayed for a time threshold that is programmed to a time period that is equal to or less than 3.5 seconds and the viewing of the image cannot be bypassed until the expiry of the time threshold.

While the particular invention, as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

1. A system for brand advertising on a global network of computers, comprising:
a. a server on a global computer network with stored digital content that is sent to clients on the global net when a specific request for it by the client;
b. a function embeds an advertising image in the digital content, where the advertising image when the content is displayed on a client, substantially obscures the digital content from being viewed;
c. the function structures the advertisement image in the digital content in a manner that the ad image is the first display seen by a receiver client when the digital content is received from the server on the global network and viewed on the client and removes the ad image from the display after a time threshold, thus enables the digital content to be viewed;
d. the advertising image is displayed for a time threshold that is programmed to a time period that is equal to or less than 3.5 seconds and the viewing of the image cannot be bypassed until the expiry of the time threshold.

2. The system as in claim 1, comprising:
a. the ad image is displayed for a time that exceeds at least the time for a subjective subliminal perception of 0.7 seconds;
b. the time period for displaying the image is limited to one from a group of, 0.7, 0.8, 0.9, 1.0, 1.1, 1.2, 1.3, 1.4, 1.5, 1.6, 1.7, 1.8, 1.9, 2.1, 2.2, 2.3, 2.4, 2.5, 2.6, 2.7, 2.8, or 2.9 seconds time period.

3. The system as in claim 1, comprising:
the ad image is one from a group of (i) a composite of a part A that of a social message and part B that of a social message sponsor, (ii) a brand awareness image for brands of a one or more businesses, or (iii) a product or service awareness image of a business.

4. The system as in claim 3, comprising:
the social message part A of a composite ad image is one from a group of (i) related to health issues, (ii) related to financial literacy, or (iii) related to habits targeted to a specific audience.

5. The system as in claim 3, comprising:
the social message sponsor part B of a composite ad image is one from a group of (i) a for-profit business, (ii) a non-profit organization, or (iii) a government agency.

6. The system as in claim 1, comprising:
the image is created with a plurality of images that are viewable within the time threshold.

7. The system as in claim 1, comprising:
multiple images are created when the digital content has multiple sections and a single advertising image is used for each section of the digital content.

8. The system as in claim 7, comprising the steps of:
the program at random decides which image would be displayed for which section of the digital content by embedded it in the digital content.

9. The system as in claim 1, comprising:
the ad image has a legend notifying the viewer of the brief nature of time the image is being displayed.

10. The system as in claim 9, comprising:
the legend is displayed as a water mark feature on a part of the image.

11. A system for brand advertising on a global network of computers, comprising:
a. a server on a global computer network with stored digital content that is sent to clients on the global net on a specific request for it;
b. a function embeds an advertising image in the digital content, where the advertising image when viewed substantially obscures the digital content from being viewed;
c. the function structures the digital content in a manner that the advertisement image is seen by a receiver client after a preprogrammed time delay T after the digital content is received from the server via the global network and viewed on the client and removes the image from the display after a time threshold, thus enables the digital content to be viewed;
d. the advertising image is displayed for a time threshold that is programmed to a time period that is equal to or less than 3.5 seconds and the viewing of the image cannot be bypassed until the expiry of the time threshold.

12. The claim as in 11, further comprising:
the time threshold is programmed to greater than and equal to 0.7 seconds and less than and equal to 2.9 seconds.

13. The claim as in 11, further comprising:
the preprogrammed time delay T is programmed to be substantially between 5 seconds and 30 seconds and is dependent upon the nature of the digital content.

14. A method of brand advertising on a global network of computers, comprising the steps of:
a. creating a digital content for storing on a server, embedding in the digital content an advertising image and structuring the digital content in a manner that the advertisement image is the first display seen by a receiver client when the digital content is received from a server on the global network and viewed on the client;
b. obscuring substantially by the advertising image the digital content from being viewed and removing the image from the display after a time threshold, enabling the digital content to be viewed;
c. programming the time threshold equal to a time period that is equal to or less than 3.5 seconds and the viewing of the image cannot be bypassed until the expiry of the time threshold.

15. The method as in claim 13, comprising the steps of:
the ad image is displayed for a time that exceeds at least the time for subliminal perception.

16. The method as in claim 13, comprising the steps of:
limiting the time period to less than or equal to 2.9 second time period.

17. The method as in claim 13, comprising the steps of:
creating the image with a plurality of images that are viewable within the time threshold.

18. The method as in claim 13, comprising the steps of:
creating multiple images when the digital content has multiple sections and using a single advertising image for each section of the digital content.

19. The method as in claim 13, comprising the steps of:
deciding at random by the program embedded in the digital content, which image would be displayed for which section of the digital content.

20. The method as in claim 13, comprising the steps of:
having by the ad image a legend notifying the viewer of the brief nature of time the image is being displayed.
